(19) United States
(12) Patent Application Publication
(10) Pub. No.: US 2008/0115407 A1
(43) Pub. Date: May 22, 2008

(54) SYSTEM AND METHOD FOR PRODUCING BIODIESEL

(76) Inventor: Mark A. Hoffman, Lakeville, MN (US)

Correspondence Address: FRASER CLEMENS MARTIN & MILLER LLC, 28366 KENSINGTON LANE, PERRYSBURG, OH, 43551, US

(21) Appl. No.: 11/943,959

(22) Filed: Nov. 21, 2007

Related U.S. Application Data
(60) Provisional application No. 60/860,541, filed on Nov. 22, 2006.

(51) Int. Cl. C10L 1/19; B01J 19/00

(52) U.S. Cl. 44/385; 422/198

(57) ABSTRACT

A system and a method are disclosed for producing biodiesel, wherein an organic fluid, a catalyst, and at least one of an alcohol, a recovered alcohol fluid, and a purified alcohol fluid undergo a reaction process, a separation process, a distillation process, and a filtration process to produce a final alkyl ester product, and wherein a cost thereof is minimized and an effectiveness thereof is maximized.

### CROSS-REFERENCE TO RELATED APPLICATION

This application claims priority to U.S. Provisional Patent Application Ser. No. 60/860,541, filed Nov. 22, 2006, the entire disclosure of which is incorporated herein by reference.

### FIELD OF THE INVENTION

The invention relates to a system and method for producing biodiesel, more particularly to a system and method capable of producing a biodiesel in large quantities, wherein a cost thereof is minimized and an efficiency thereof is maximized.

### BACKGROUND OF THE INVENTION

Biodiesel is the commonly used term for certain fuel and fuel additives, for use in internal combustion engines, namely engines designed for diesel oil as a fuel. Representative examples of biodiesel include methyl esters, ethyl esters, and other compounds generally produced by a reaction of acids and alcohols. Typically, the compounds are added to diesel fuel in amounts ranging from 2% (B2) to 20% (B20), although biodiesel can be used as a fuel in its pure 100% (B100) form. Biodiesel is produced from renewable sources such as natural fats and oils found in rape seeds, degummed soybeans, yellow grease, and the like, for example. Biodiesel is also non-toxic and bio-degradable. Compared to petroleum-based diesel, biodiesel has significantly lower emissions when burned, due in part to its extremely low levels of sulfur. Biodiesel has excellent lubricating qualities as compared to traditional diesel. Given the beneficial qualities of biodiesel and the effort of the U.S. to reduce dependency on foreign oil, demand continues to increase.

There are different production processes used to create biodiesel depending on the origin and quality of the raw material. Generally, biodiesel is produced when a triglyceride, a diglyceride, or a monoglyceride component of the natural fats and oils is converted into fatty acid ester. This transesterification reaction is achieved by adding an alcohol such as methanol, and a catalyst such as an alkali, an acid, and a metal oxide catalyst to the raw material. After the transesterification reaction, a mixture of glycerol and fatty acid methyl ester (FAME) is present. Typically, the FAME is separated from the glycerol using gravity. The amount of residual glycerin in the FAME affects the quality of biodiesel. Therefore, complete separation is desired. The separated glycerol is then distilled to remove the alcohol and produce glycerin.

The FAME is also distilled to remove the alcohol. Thereafter, the FAME is filtered using a water-wash process with a soap product, dried, and clarified to remove any remaining contaminant materials that are detrimental to the quality of the fuel such as soaps, metals, and the like, for example. The product produced from the distillation and filtration processes is biodiesel (fatty acid ester).

As an alternative to the water-wash filtration process which causes methyl ester loss and emulsification, the FAME can be mixed with an adsorbent such as a magnesium silicate. The adsorbent filters excess alcohol, residual glycerin, contaminants, fatty acids and soaps to produce biodiesel, as well as a byproduct with potential value as animal feed, fertilizer, or compost.

It would be desirable to develop a system and method for producing biodiesel, wherein a cost thereof is minimized and an efficiency thereof is maximized.

### SUMMARY OF THE INVENTION

In concordance and agreement with the present invention, a system and method for producing biodiesel, wherein a cost thereof is minimized and an efficiency thereof is maximized, has surprisingly been discovered.

In one embodiment, the system for producing biodiesel, the system comprising a plurality of storage tanks, each of the storage tanks adapted to contain one of an organic liquid, an alcohol, a recovered alcohol fluid, a purified alcohol fluid, a catalyst, a glycerin, and a final alkyl ester product; at least one reactor in fluid communication with at least one of the storage tanks, the at least one reactor adapted to produce a process liquid from the organic liquid, the catalyst, and at least one of the alcohol, the recovered alcohol fluid, and the purified alcohol fluid; at least one separator in fluid communication with the at least one reactor, the at least one separator adapted to separate the process liquid into a glycerol stream and a fatty acid alkyl ester stream; a plurality of evaporators in fluid communication with the at least one separator, wherein one of the evaporators adapted to remove the alcohol and the water from the fatty acid alkyl ester stream to produce an alkyl ester stream, and another of the evaporators adapted to remove the alcohol from the glycerol stream to produce a glycerin stream; a plurality of condensers in fluid communication with the evaporators, wherein each of the condensers is adapted to condense the alcohol and the water removed by the evaporators to produce the recovered alcohol fluid; a plurality of heat exchangers in fluid communication with the evaporators and at least one of the storage tanks, wherein one of the heat exchangers is adapted to heat one of the fatty acid alkyl ester stream and the glycerol stream, and another of the heat exchangers is adapted to cool one of the alkyl ester stream and the glycerin stream; a mixing tank in fluid communication with at least one of the heat exchangers, wherein the mixing tank is adapted to receive the alkyl ester stream and a filter aid adapted to adsorb impurities thereof; and at least one filter in fluid communication with the mixing tank and one of the storage tanks, wherein the at least one filter is adapted to remove from the alkyl ester stream at least one of the filter aid and the impurities, to produce a final alkyl ester product.

In another embodiment, the method of producing biodiesel comprising the steps of feeding an organic liquid, a catalyst, and at least one of an alcohol, a recovered alcohol fluid, and a purified alcohol fluid into at least one reactor to produce a process liquid; feeding the process liquid into at least one separator, wherein the process liquid is separated into a fatty acid alkyl ester stream including an amount of fatty acid alkyl esters, alcohol, and water, and a glycerol stream including an amount of glycerin, alcohol, and water; feeding the fatty acid alkyl ester stream into at least one evaporator for removal of the alcohol and water to produce an alkyl ester stream; feeding the glycerol stream into at least one evaporator for removal of the alcohol to produce a glycerin stream; feeding the alcohol and the water removed by the at least one evaporator into at least one condenser to produce the recovered alcohol fluid; feeding the alkyl ester stream into a mixing tank, wherein the mixing tank is adapted to mix the alkyl ester stream with a filter aid; and feeding the alkyl ester stream mixed with the filter aid through at least one filter to remove the filter aid and impurities to produce a final alkyl ester product.

In another embodiment, the method of producing biodiesel comprising the steps of feeding an organic liquid, a catalyst, and at least one of an alcohol, a recovered alcohol fluid, and a purified alcohol fluid into at least one reactor to produce a process liquid; feeding the process liquid into at least one separator, wherein the process liquid is separated into a fatty acid alkyl ester stream including an amount of fatty acid alkyl esters, alcohol, and water, and a glycerol stream including an amount of glycerin, alcohol, and water; feeding the fatty acid alkyl ester stream into at least one evaporator for removal of the alcohol and water to produce an alkyl ester stream; feeding the glycerol stream into at least one evaporator for removal of the alcohol and water to produce a glycerin stream; feeding the alcohol and the water removed by the at least one evaporator into at least one condenser to produce the recovered alcohol fluid; feeding the recovered alcohol fluid into at least one evaporator to produce a purified alcohol fluid; feeding the alkyl ester stream into a mixing tank, wherein the alkyl ester stream is mixed with a filter aid; feeding the alkyl ester stream mixed with the filter aid through at least one filter to remove the filter aid and impurities to produce a filtered alkyl ester stream, wherein the at least one filter is precoated with a precoat slurry produced from an alcohol and a precoat material; and feeding the filtered alkyl ester stream through at least one cloth filter to produce the final alkyl ester product.

Advantages of the above invention are the capability of large scale implementation suitable for a manufacturing facility and the production of a high quality biodiesel. Production rates can range from 600 pounds per hour to an excess of 100,000 pounds per hour, limited only by practical factors such as facility size, economic viability, material availability, and demand for biodiesel.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a block flow diagram of a method for producing biodiesel according to an embodiment of the invention;

FIG. 2 is a schematic flow diagram of a subsystem for practicing the reaction process of the method illustrated in FIG. 1 according to an embodiment of the invention;

FIG. 3 is a schematic flow diagram of a subsystem for practicing the separation process of the method illustrated in FIG. 1 according to an embodiment of the invention;

FIG. 4 is a schematic flow diagram of a subsystem for practicing the distillation process of the method illustrated in FIG. 1 according to an embodiment of the invention;

FIG. 5 is a schematic flow diagram of a subsystem for practicing the filtration process of the method illustrated in FIG. 1 according to an embodiment of the invention;

FIG. 6 is a schematic flow diagram of a subsystem for practicing the reaction process of the method illustrated in FIG. 1 according to another embodiment of the invention;

FIG. 7 is a schematic flow diagram of a subsystem for practicing the distillation process of the method illustrated in FIG. 1 according to another embodiment of the invention; and

FIG. 8 is a schematic flow diagram of a subsystem for practicing the distillation process of the method illustrated in FIG. 1 according to another embodiment of the invention.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

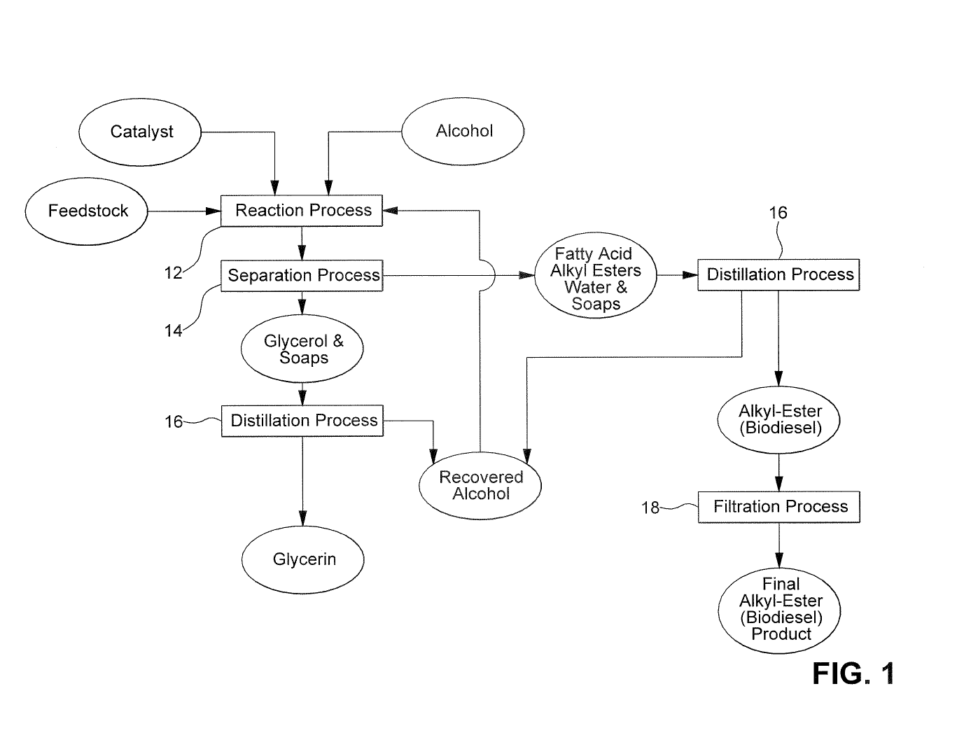

FIG. 1 is a block flow diagram illustrating a method for producing biodiesel 10 according to an embodiment of the invention. The method 10 includes a reaction process 12 also known as a transesterification process, a separation process 14, a distillation process 16, and a filtration process 18.

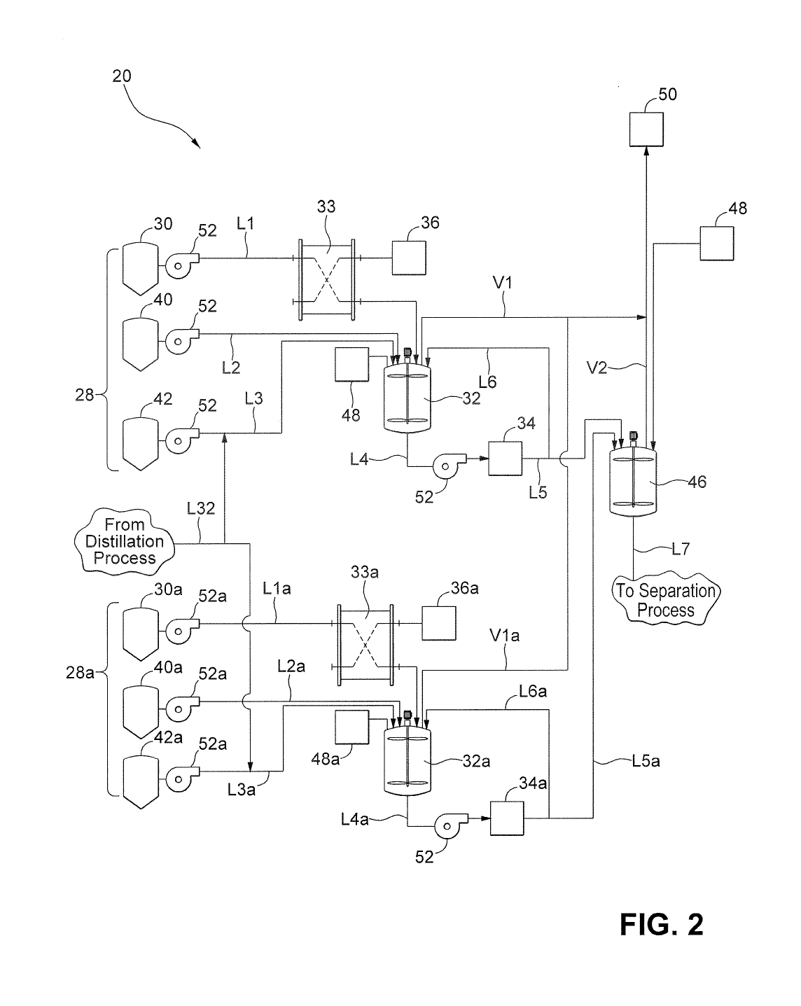

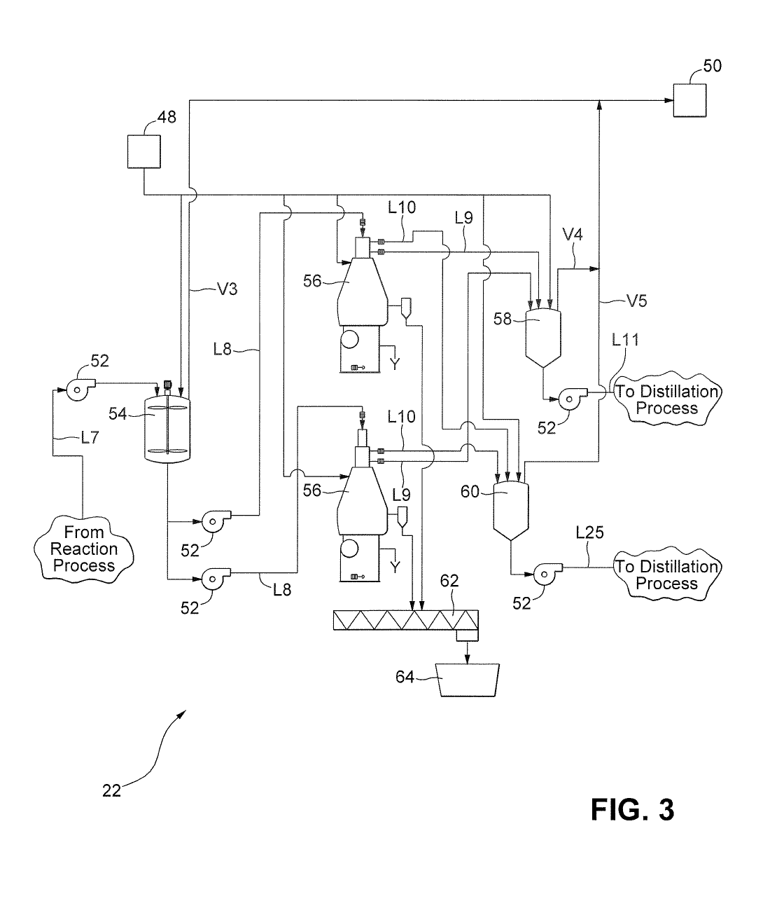

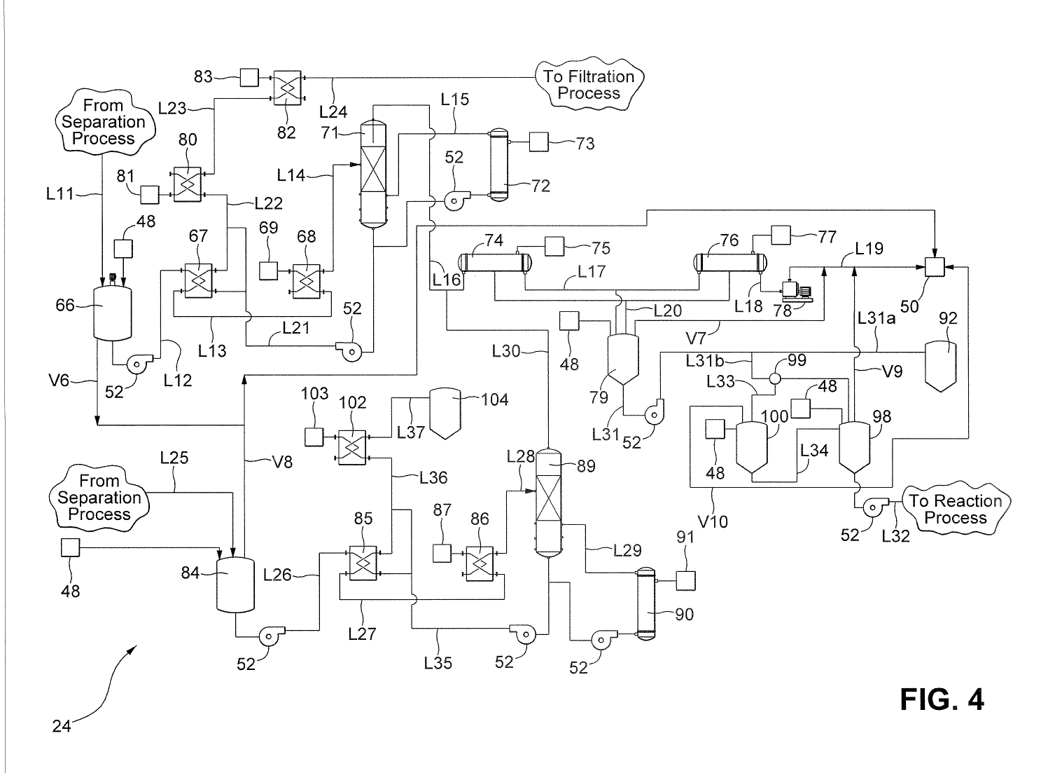

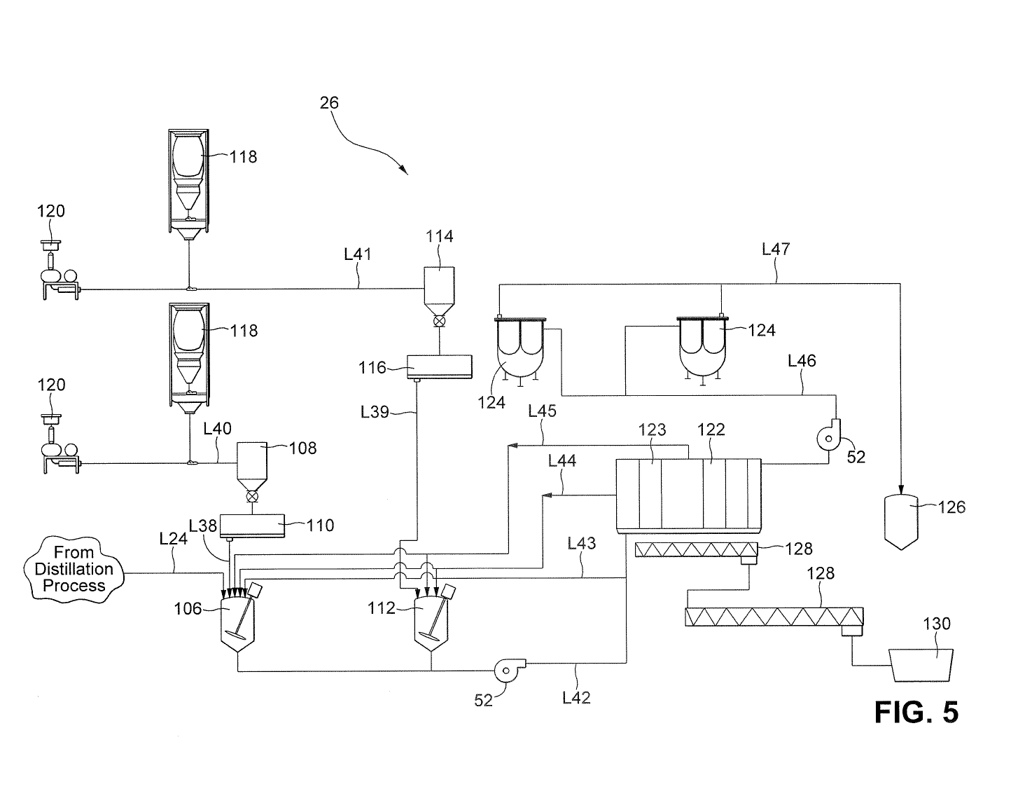

FIGS. 2 thru 5 show a system adapted to practice the method for producing biodiesel 10 according to an embodiment of the invention. The system includes a subsystem 20 as shown in FIG. 2 for practicing the reaction process 12, a subsystem 22 as shown in FIG. 3 for practicing the separation process 14, a subsystem 24 as shown in FIG. 4 for practicing the distillation process 16, and a subsystem 26 as shown in FIG. 5 for practicing the filtration process.

As illustrated in FIG. 2, the subsystem 20 is adapted to convert an organic fluid such as a triglyceride, a diglyceride, and a monoglyceride feedstock into a process liquid. It is understood that the organic fluid may be natural fats and oils such as soy oil, canola oil, corn oil, sunflower oil, palm oil, animal fats, and the like, for example. The subsystem 20 employs two parallel production lines 28, 28a. For simplicity only the production line 28 will be discussed herein.

In the embodiment shown, a first tank 30 is in fluid communication with one of a tank 32 and a static mixer (not shown) through a line L¹. The tank 30 is adapted to store the organic fluid. The organic fluid is low in moisture, low in free fatty acids, low in phosphorous, low in soaps, and low in unsaponifiables. It is understood that other organic fluids having varying percentages of moisture, free fatty acids, soaps, and unsaponifiables can be used as desired if a pretreatment process (not shown) is permitted. In the embodiment shown, each of the tank 32 and the static mixer is adapted to receive a predetermined amount of the organic fluid. Although the predetermined amount of the organic fluid in the embodiment shown is 1000 pounds, it is understood that the predetermined amount of the organic fluid can vary as desired. It is also understood that the tank 32 can be any conventional tank as desired.

A preheater 33 may be included in the subsystem 20. In the embodiment shown, the preheater 33 is in fluid communication with the tank 30 and one of the tank 32 and the static mixer. The preheater 33 is adapted to preheat the organic fluid to a desired temperature to decrease a time to complete the reaction process 12. In the embodiment shown, the desired temperature is in a range of 70 degrees Fahrenheit to 140 degrees Fahrenheit, although the desired temperature can vary as desired. The preheater 33 can include a jacketed tank and a heat exchanger adapted to heat the organic fluid such as a shell and tube heat exchanger and a plate and frame heat exchanger, for example. In the embodiment show, the preheater 33 is adapted to heat the organic fluid using a heated fluid 36 such as steam, hot water, and heated heat transfer fluid, for example.

A second tank 40 is in fluid communication with one of the tank 32 and the static mixer through a line L2. The tank 40 is adapted to store a catalyst such as sodium methoxide (CH₃NaO) and potassium methoxide (CH₃KO), for example. In the embodiment shown, each of the tank 32 and the static mixer is adapted to receive a predetermined amount of the catalyst. Although the predetermined amount of the catalyst in the embodiment shown is in a range of 10 pounds to 30 pounds, it is understood that the predetermined amount of the catalyst can vary as desired.

A third tank 42 is in fluid communication with one of the tank 32 and the static mixer through a line L3. The tank 42 is adapted to store an alcohol such as methanol (CH₃OH) and ethanol (C₂H₆O), for example. In the embodiment shown, each of the tank 32 and the static mixer is adapted to receive a predetermined amount of the alcohol. Although the predetermined amount of the alcohol in the embodiment shown is in a range of 100 pounds to 150 pounds, it is understood that the predetermined amount of the alcohol can vary as desired.

The production line 28 may include a fourth tank (not shown) adapted to store water. The tank is in fluid communication with one of the tank 32 and the static mixer through a line (not shown). Each of the tank 32 and the static mixer is adapted to receive a predetermined amount of the water. Although the predetermined amount of the water is in a range of 0 pounds to 60 pounds, it is understood that the predetermined amount of the water can vary as desired. It is also understood that each of the tank 32 and the static mixer is adapted to mix the organic fluid, the catalyst, and at least one of the alcohol, a recovered alcohol fluid, a purified alcohol fluid, and water, producing a pre-reaction mixture.

In the embodiment shown, one of the tank 32 and static mixer is in fluid communication with at least one reactor 34 through a line L4. The at least one reactor 34 is adapted to maximize an exposure of the organic fluid to the catalyst and at least one of the alcohol, the recovered alcohol fluid, and the water, while minimizing a time and a temperature of the reaction process 12. In the embodiment shown, the at least one reactor 34 is a high shear in-line mixer such as the Shock Wave Power™ reactor manufactured by Hydrodynamics, Inc. It is understood that other reactors and mixers can be used if desired. The at least one reactor 34 is in fluid communication with a tank 46 through a line L5. It is understood that the at least one reactor 34 may also be in fluid communication with one of the tank 32 and the static mixer through a return line L6 adapted to circulate the process liquid back to one of the tank 32 and the static mixer. It is also understood that the tank 46 can be any conventional tank such as an agitated surge tank, for example. In the embodiment shown, the process liquid includes glycerol, soaps, salts, and fatty acid alkyl esters. The fatty acid alkyl esters may be any fatty acid alkyl esters such as fatty acid methyl esters and fatty acid ethyl esters, for example. As illustrated in FIG. 2, the tank 46 is adapted to receive the process liquid produced from both of the production lines 28, 28a.

Each of the tanks 32, 46 may be blanketed with nitrogen 48 to militate against oxidation of the pre-reaction mixture and the process liquid. The nitrogen 48 is vented to a thermal oxidizer 50 through vents V1, V2, respectively. It is understood that the thermal oxidizer 50 is adapted to receive the nitrogen 48 used in both the production lines 28, 28a.

Optionally, a plurality of pumps 52 is provided to cause each of the organic fluid, the catalyst, and the alcohol to flow from the respective tanks 30, 40, 42 through the lines L1, L2, L3, respectively, to one of the tank 32 and the static mixer. Another pump 52 may also be provided to cause the pre-reaction mixture to flow from one of the tank 32 and the static mixer through the line L4 to the at least one reactor 34, and the process liquid to flow from the at least one reactor 34 through the lines L5, L6 to the tank 46 and to one of the tank 32 and the static mixer, respectively.

As illustrated in FIG. 3, the subsystem 22 includes a tank 54 in fluid communication with the tank 46 through a line L7. The tank 54 is adapted to receive a predetermined amount of the process liquid at a desired temperature. Although the predetermined amount of the process liquid in the embodiment shown is in a range of 1100 pounds to 1250 pounds, it is understood that the predetermined amount of process liquid can vary as desired. In the embodiment shown, the desired temperature is in a range of 90 degrees Fahrenheit to 140 degrees Fahrenheit, although it is understood that the temperature can vary as desired. The tank 54 is also in fluid communication with at least one separator 56 through at least one line L8. The tank 54 is adapted to receive the process liquid. It is understood that the tank 54 can be any tank as desired such as an agitated tank having a slow sweep agitator, for example.

In the embodiment shown, the at least one separator 56 is adapted to separate the glycerin in the process fluid from the fatty acid alkyl esters, producing a glycerol stream and a fatty acid alkyl ester stream. Although the at least one separator 56 in the embodiment shown is a vertical bowl, stacked disc centrifuge, it is understood that other separators can be employed as desired such as a horizontal bowl decanter, a batch centrifuge, and a batch continuous flow settling tank, for example.

The at least one separator 56 is also in fluid communication with a pair of collection tanks 58, 60 through lines L9 and lines L10, respectively. The collection tank 58 is adapted to receive the glycerol stream. In the embodiment shown, the glycerol stream includes an amount of glycerin in a range of 100 pounds to 130 pounds, an amount of alcohol in a range of 1 pound to 10 pounds, an amount of soaps in a range of 1 pound to 4 pounds, and an amount of water in a range of 0 pounds to 3 pounds, although it is understood that the amounts of the glycerin, the alcohol, the soaps, and the water can vary as desired.

The collection tank 60 is adapted to receive a fatty acid alkyl ester stream. In the embodiment shown, the fatty acid alkyl ester stream includes an amount of fatty acid alkyl esters in a range of 950 pounds to 1100 pounds, an amount of alcohol in a range of 1 pound to 10 pounds, an amount of soaps in a range of 1 pound to 6 pounds, and an amount of water in a range of 0 pounds to 6 pounds, although it is understood that the amounts of the fatty acid alkyl esters, the alcohol, the soaps, and the water can vary as desired.

A conveyor 62 is provided in the subsystem 22 to transport solids removed from the at least one separator 56 such as the soaps, for example, to a disposal container 64. The conveyor 62 can be any conventional conveyor such as a screw conveyor, for example.

Each of the tanks 54, 58, 60 and the at least one separator 56 may be blanketed with nitrogen 48 to militate against oxidation of the process liquid, the glycerol, the alcohol, and the fatty acid alkyl esters. The nitrogen 48 is vented to the thermal oxidizer 50 through vents V3, V4, V5, respectively.

Optionally, a plurality of pumps 52 is provided to cause the process liquid to flow from the tank 46, shown in FIG. 2, through line L7 to the tank 54, and from the tank 54 through the at least one line L8 to the at least one separator 56.

FIG. 4 illustrates the subsystem 24. In the embodiment shown, a tank 66 is in fluid communication with the collection tank 60, shown in FIG. 3, through a line L11. The tank 66 can be any conventional tank as desired. The tank 66 is also in fluid communication with a heat exchanger 67 through a line L12. It is understood that the heat exchanger 67 can be in direct fluid communication with the tank 60, shown in FIG. 3, through the line L11 if desired. In the embodiment shown, the heat exchanger 67 is an economizer adapted to use a hot feed to heat the fatty acid alkyl ester stream, although it is understood that the heat exchanger 67 can be any conventional heat exchanger such as a shell and tube heat exchanger, a plate and frame heat exchanger, and a spiral heat exchanger, for example.

The heat exchanger 67 is in fluid communication with another heat exchanger 68 through a line L13. It is understood that the heat exchanger 68 can be any conventional heat exchanger such as a shell and tube heat exchanger, a plate and frame heat exchanger, and a spiral heat exchanger, for example. The heat exchanger 68 is adapted to further heat the fatty acid alky ester stream to a desired temperature using a heated fluid 69 such as steam, hot water, and heated heat transfer fluid, for example. Although the desired temperature of the fatty acid alkyl ester stream in the embodiment shown is in a range of 150 degrees Fahrenheit to 350 degrees Fahrenheit, it is understood that the temperature can vary as desired.

The heat exchanger 68 is in fluid communication with an evaporator 71 through a line L14, wherein the evaporator 71 is under a vacuum provided by a vacuum pump (not shown). In the embodiment shown, the vacuum is in a range of 2 inches mercury to 26 inches mercury, although it is understood that the vacuum can vary as desired. It is also understood that the evaporator 71 can be any conventional evaporator such as a flash tank, a rising film evaporator, a falling film evaporator, and a packed stripping column, for example. The evaporator 71 is adapted to distill the fatty acid alkyl esters, separating the alcohol and the water vapor from an alkyl ester stream, wherein the alkyl ester stream includes alkyl esters and the soaps.

In the embodiment shown, the evaporator 71 is in fluid communication with a reboiler 72 through a circulation line L15. The reboiler 72 is adapted to further heat the alkyl esters using a heated fluid 73 such as steam, for example. The evaporator 71 is also in fluid communication with the heat exchanger 67 through a line L21. In the embodiment shown, the heat exchanger 67 is an economizer adapted to use a fatty acid alkyl ester feed into the heat exchanger 68 to cool the alkyl ester stream.

The heat exchanger 67 is also in fluid communication with another heat exchanger 80 through a line L22. It is understood that the heat exchanger 80 can be any conventional heat exchanger such as a shell and tube heat exchanger, a plate and frame heat exchanger, and a spiral heat exchanger, for example. In the embodiment shown, the heat exchanger 80 is adapted to use a cooled fluid 81 such as water, for example, to further cool the alkyl ester stream to a desired temperature. Although the desired temperature is in a range of 70 degrees Fahrenheit to 160 degrees Fahrenheit, it is understood the temperature can vary as desired.

In the embodiment shown, the heat exchanger 80 is in fluid communication with the evaporator 71 through the lines L21, L22 and another heat exchanger 82 through a line L23. It is understood that the heat exchanger 80 can be in direct fluid communication with the subsystem 26 through the line L23 if desired. It is also understood that the heat exchanger 82 can be any conventional heat exchanger such as a shell and tube heat exchanger, a plate and frame heat exchanger, and a spiral heat exchanger, for example. The heat exchanger 82 is adapted to use a chilled fluid 83 to further cool the alkyl ester stream. In the embodiment shown, the heat exchanger 82 is in fluid communication with the subsystem 26 through a line L24.

In the embodiment shown, a tank 84 is in fluid communication with the collection tank 58, shown in FIG. 3, through a line L25. The tank 84 can be any conventional tank as desired. The tank 84 is also in fluid communication with a heat exchanger 85 through a line L26. It is understood that the heat exchanger 85 can be in direct fluid communication with the tank 58 through the line L25 if desired. In the embodiment shown, the heat exchanger 85 is an economizer adapted to use a hot feed to heat the glycerol stream, although it is understood that the heat exchanger 85 can be any conventional heat exchanger such as a shell and tube heat exchanger, a plate and frame heat exchanger, and a spiral heat exchanger, for example.

The heat exchanger 85 is in fluid communication with another heat exchanger 86 through a line L27. The heat exchanger 86 can be any conventional heat exchanger such as a shell and tube heat exchanger, a plate and frame heat exchanger, and a spiral heat exchanger, for example. The heat exchanger 86 is adapted to further heat the glycerol stream to a desired temperature using a heated fluid 87 such as steam, hot water, and heated heat transfer fluid, for example. Although the desired temperature of the glycerol stream in the embodiment shown is in a range of 140 degrees Fahrenheit to 220 degrees Fahrenheit, it is understood that the temperature can vary as desired.

The heat exchanger 86 is in fluid communication with an evaporator 89 through a line L28, wherein the evaporator 89 is under a vacuum provided by a vacuum pump (not shown). In the embodiment shown, the vacuum is in a range of 2 inches mercury to 26 inches mercury, although it is understood that the vacuum can vary as desired. It is also understood that the evaporator 89 can be any conventional evaporator such as a flash tank, a rising film evaporator, a falling film evaporator, and a packed stripping column, for example. The evaporator 89 is adapted to distill the glycerol stream, separating the alcohol vapor from a glycerin stream, wherein the glycerin stream includes glycerin, water, and soaps. In the embodiment shown, the evaporator 89 is in fluid communication with a reboiler 90 through a circulation line L29. The reboiler 90 is adapted to further heat the glycerin stream using a heated fluid 91 such as steam, for example.

The evaporator 89 is also in fluid communication with a heat exchanger 85 through a line L35. In the embodiment shown, the heat exchanger 85 is an economizer adapted to use a glycerol feed into the heat exchanger 86 to cool the glycerin stream.

The heat exchanger 85 is also in fluid communication with another heat exchanger 102 through a line L36. It is understood that the heat exchanger 102 is any conventional heat exchanger such as a shell and tube heat exchanger, a plate and frame heat exchanger, and a spiral heat exchanger, for example. In the embodiment shown, the heat exchanger 102 is adapted to use a cooled fluid 103 such as water, for example, to cool the glycerin stream to a desired temperature. Although the desired temperature is in a range of 80 degrees Fahrenheit to 160 degrees Fahrenheit, it is understood the temperature can vary as desired. The heat exchanger 102 is in fluid communication with the evaporator 89 through the lines L35, L36 and a tank 104 through a line L37. The tank 104 is adapted to store the cooled glycerin stream. It is understood that the tank 104 may be in fluid communication with a purification subsystem (not shown) for purifying the cooled glycerin stream.

Each of the evaporators 71, 89 is also in fluid communication with a condenser 74 through respective lines L16, L30. It is understood that the condenser 74 can be any conventional condenser such as a shell and tube condenser and a plate and frame condenser, for example. The condenser 74 is adapted to use a cooled fluid 75 such as water, for example, at a desired temperature to condense the alcohol and water vapor flashed off by at least one the evaporators 71, 89. In the embodiment shown, the desired temperature of the cooled fluid 75 is in a range of 40 degrees Fahrenheit to 95 degrees Fahrenheit, although it is understood that the temperature can vary as desired.

The condenser 74 is in fluid communication with another condenser 76 through a line L17. It is understood that the condenser 76 can be any conventional condenser as desired. The condenser 76 is adapted to use a chilled fluid 77 such as water, a glycol solution, and the like, for example, at a desired temperature to condense the alcohol and the water vapor not condensed by the condenser 74. In the embodiment shown, the desired temperature of the chilled fluid 77 is in a range of 0 degrees Fahrenheit to 40 degrees Fahrenheit, although it is understood that the temperature can vary as desired.

The condenser 76 is in fluid communication with a vacuum pump 78 through a line L18. The vacuum pump 78 is adapted to permit any remaining alcohol and water vapor not condensed by the condensers 74, 76 to flow therethrough. The vacuum pump 78 is in fluid communication with a pollution control device through a line L19. In the embodiment shown, the pollution control device is the thermal oxidizer 50, although it is understood that the pollution control device can be any control device such as a carbon adsorption system and a scrubber, for example. The pollution control device is adapted to receive any remaining alcohol and water vapor.

The condensers 74, 76 are also in fluid communication with a collection tank 79 through a line L20. It is understood that the tank 79 can be any conventional tank as desired. The tank 79 is adapted to receive a recovered alcohol fluid from the condensers 74, 76, wherein the recovered alcohol fluid includes alcohol and water.

The tank 79 is in fluid communication with a tank 92 through a line L31a. The tank 92 can be any conventional tank as desired. The tank 92 is adapted to store at least a fraction of the recovered alcohol fluid. The tank 79 is also in fluid communication with a tank 98 through a line L31b. The tank 98 can be any conventional tank as desired. The tank 98 is adapted to store a predetermined amount of the alcohol and a predetermined amount of the water of the recovered alcohol fluid for reuse in the reaction process 12. In the embodiment shown, the predetermined amount of the alcohol is in a range of 2 pounds to 12 pounds and the predetermined amount of the water is in a range of 0 pounds to 6 pounds, although the predetermined amounts of the alcohol and the water can vary as desired.

The tank 98 is in fluid communication with the subsystem 20 through a line L32. A densitometer 99 may be provided to determine the amount of the water in the recovered alcohol fluid flowing through the line L31b. In the embodiment shown, the densitometer 99 is in fluid communication with a tank 100 through a line L33. The tank 100 is adapted to regulate the flow of the recovered alcohol fluid through a line L34 to the tank 98 to meet a water requirement of the subsystem 20.

Each of the tanks 66, 79, 84, 98, 100 may be blanketed with nitrogen 48 to militate against oxidation of the glycerol, the fatty acid alkyl esters, and at least one of the alcohol and the recovered alcohol fluid. The nitrogen 48 is vented to the thermal oxidizer 50 through vents V6, V7, V8, V9, V10. Optionally, a plurality of pumps 52 is provided in the subsystem 24 to cause the glycerol stream, the fatty acid alkyl stream, the glycerin stream, the alkyl ester stream, and the recovered alcohol fluid to flow therethrough.

As illustrated in FIG. 5, the subsystem 26 is adapted to convert the alkyl ester stream into a final alkyl ester product, also referred to as biodiesel. A tank 106 is in fluid communication with the heat exchanger 82, shown in FIG. 4, through the line L24. It is understood that the tank 106 can be any conventional tank as desired. The tank 106 is adapted to receive the alkyl ester stream and a predetermined amount of a filter aid such as bleaching clay and magnesium silicate, for example. The filter aid is adapted to adsorb the water and soaps from the alkyl ester stream. In the embodiment shown, the predetermined amount of the filter aid is in a range of 0.05% to 0.5% of a mass of the alkyl ester stream, although it is understood that the predetermined amount of the filter aid can vary as desired. A tank 108 is in fluid communication with the tank 106 through a line L38. It is understood that the tank 108 can be any conventional tank as desired. A feeder 110 is adapted to transport the filter aid from the tank 108 to the tank 106.

One of tank 112 and an inline filter (not shown) is in fluid communication with a tank 114 through a line L39. It is understood that the tanks 112, 114 can be any conventional tanks as desired. One of the tank 112 and the inline filter is adapted to receive an amount of alcohol and an amount of a precoat material to produce a precoat slurry. It is understood that the precoat material can be any conventional precoat material such as diatomaceous earth, for example. A feeder 116 is adapted to transport the precoat material from the tank 114 to the tank 112.

Optionally, a plurality of bag unloaders 118 and associated blowers 120 are provided to dispense and cause the filter aid and the precoat material to flow through lines L40, L41 to the tank 108 and the tank 114, respectively.

Each of the tanks 106, 112 is in fluid communication with a filter 122 through a line L42. It is understood that the filter 122 can be any conventional filter such as a plate filter press, a continuous filter, a candle filter, a leaf filter, and a centrifugal discharge filter, for example. In the embodiment shown, the filter 122 includes at least one of a plurality of screens 123 and fabric (not shown). The filter 122 is adapted to remove the filter aid and other impurities from the alkyl ester stream. The filter 122 may include the precoat slurry disposed thereon to improve filtration of the alkyl ester stream. It is understood that the alkyl ester stream mixed with the filter aid, prior to flowing through the filter 122, can be circulated through a line L43 back to the tank 106. It is also understood that both the precoat slurry and the alkyl ester stream mixed with the filter aid, after flowing through a portion of the filter 122, can be circulated through respective lines L44, L45 back to the tanks 106, 112, if desired.

Optionally, the filter 122 is in fluid communication with a plurality of cloth filters 124 through a line L46. The cloth filters 124 are adapted to remove any remaining impurities from the alkyl ester stream. In the embodiment shown, the cloth filters 124 are disposed in the subsystem 26 in parallel relation to each other to maintain a continuous filtering during a replacement of one of the filters 124. Although the filters 124 in the embodiment shown are of a size in the range of 1 micron to 5 microns, it is understood that the size can vary as desired.

A tank 126 is in fluid communication with one of the filter 122 and the plurality of cloth filters 124 through a line L47. It is understood that the tank 126 can be any conventional tank as desired. The tank 126 is adapted to store the final alkyl ester product.

At least one conveyor 128 is provided in the subsystem 26 to transport the filter aid and other impurities removed from the alkyl ester stream to a disposal container 130. The conveyor 128 can be any conventional conveyor such as a screw conveyor, for example.

Optionally, a plurality of pumps 52 is provided in the subsystem 26 to cause the alkyl ester stream mixed with the filter aid and the precoat slurry to flow through the line L42 to the filter 122, and the filtered alkyl ester stream to flow through the line L46 to the plurality of cloth filters 124.

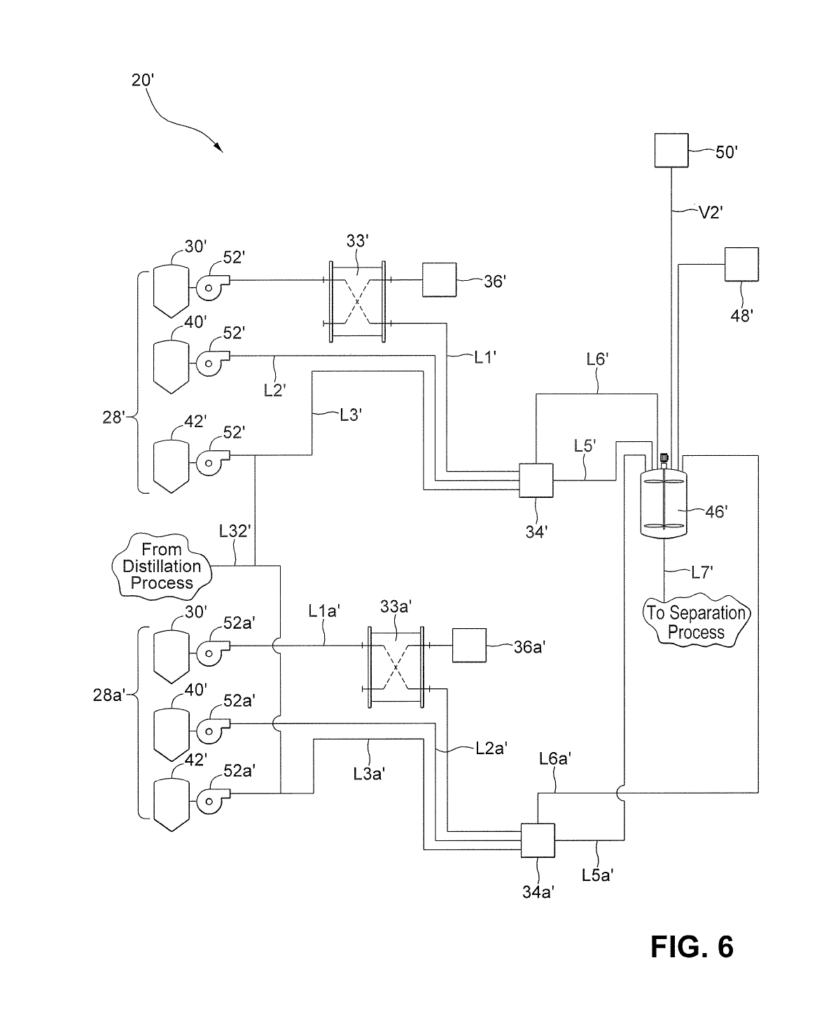

FIG. 6 illustrates another embodiment of the subsystem 20 for completing the reaction process 12. Reference numerals for similar structure in respect of the description of FIG. 2 are repeated in FIG. 6 with a prime (′) symbol. The subsystem 20′ is adapted to convert an organic fluid such as a triglyceride, a diglyceride, and a monoglyceride feedstock into a process liquid. The subsystem 20′ employs two parallel production lines 28′, 28a′. For simplicity only the production line 28′ will be discussed herein.

In the embodiment shown, a first tank 30′ is in fluid communication with at least one reactor 34′ through a line L1′. The tank 30′ is adapted to store the organic fluid. The organic fluid is low in moisture, low in free fatty acids, low in phosphorous, low in soaps, and low in unsaponifiables. It is understood that other organic fluids having varying percentages of moisture, free fatty acids, soaps, and unsaponifiables can be used as desired if a pretreatment process (not shown) is permitted.

A preheater 33′ may be included in the subsystem 20′. In the embodiment shown, the preheater 33′ is in fluid communication with the tank 30′ and at least one reactor 34′. The preheater 33′ is adapted to preheat the organic fluid to a desired temperature to decrease a time to complete the reaction process 12. In the embodiment shown, the desired temperature is in a range of 70 degrees Fahrenheit to 140 degrees Fahrenheit, although the desired temperature can vary as desired. The preheater 33′ can include a jacketed tank and a heat exchanger adapted to heat the organic fluid such as a shell and tube heat exchanger and a plate and frame heat exchanger, for example. The preheater 33′ is adapted to heat the organic fluid using a heated fluid 36′ such as steam, hot water, and heated heat transfer fluid, for example.

A second tank 40′ is in fluid communication with the at least one reactor 34′ through a line L2′. The tank 40′ is adapted to store a catalyst such as sodium methoxide (CH₃NaO) and potassium methoxide (CH₃KO), for example. A third tank 42′ is in fluid communication with the at least one reactor 34′ through a line L3′. The tank 42′ is adapted to store an alcohol such as methanol (CH₃OH) and ethanol (C₂H₆O), for example. The production line 28′ may include a fourth tank (not shown) adapted to store water. The tank is in fluid communication with the at least one reactor 34′ through a line (not shown).

In the embodiment shown, the at least one reactor 34′ is adapted to receive the organic fluid, the catalyst, and at least one of the alcohol, a recovered alcohol fluid, a purified alcohol fluid, and water. The at least one reactor 34′ is adapted to maximize an exposure of the organic fluid to the catalyst and at least one of the alcohol, the recovered alcohol fluid, and the purified alcohol fluid, while minimizing a time and a temperature of the reaction process 12. In the embodiment shown, the at least one reactor 34′ is a high shear in-line mixer such as the Shock Wave Power reactor manufactured by Hydrodynamics, Inc. It is understood that other reactors and mixers can be used if desired.

The at least one reactor 34′ is in fluid communication with a tank 46′ through a line L5′. It is understood that the tank 46′ may also be in fluid communication with the at least one reactor 34′ through a return line L6′ adapted to circulate the process liquid back to the at least one reactor 34′ to complete the reaction process 12. It is also understood that the tank 46′ can be any tank such as an agitated surge tank, for example. In the embodiment shown, the process liquid includes glycerol, soaps, salts, and fatty acid alkyl esters. The fatty acid alkyl esters may be any fatty acid alkyl esters such as fatty acid methyl esters and fatty acid ethyl esters, for example. As illustrated in FIG. 6, the tank 46′ is adapted to receive the process liquid produced from both of the production lines 28′, 28a′. The tank 46′ may be blanketed with nitrogen 48′ to militate against oxidation of the process liquid. The nitrogen 48′ is vented to a thermal oxidizer 50′ through a vent V2′. It is understood that the thermal oxidizer 50′ is adapted to receive the nitrogen 48′ used in both the production lines 28′, 28a′.

Optionally, a plurality of pumps 52′ is provided to cause each of the organic fluid, the catalyst, and the alcohol to flow from the respective tanks 30′, 40′, 42′ through the lines L1′, L2′, L3′, respectively, and through the at least one reactor 34′ to the tank 46′.

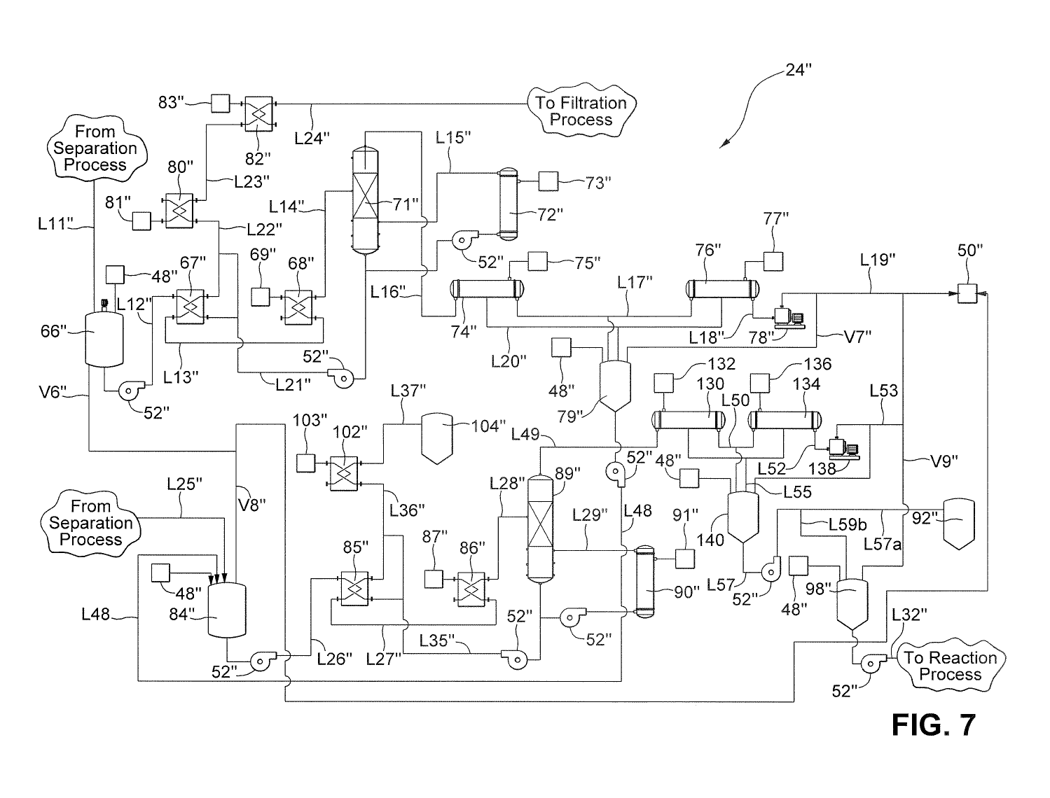

FIG. 7 illustrates another embodiment of the subsystem 24 for completing the distillation process 16. Reference numerals for similar structure in respect of the description of FIG. 4 are repeated in FIG. 7 with a prime (″) symbol.

In the embodiment shown, a tank 66″ is in fluid communication with the collection tank 60, shown in FIG. 3, through a line L11″. The tank 66″ can be any conventional tank as desired. The tank 66″ is also in fluid communication with a heat exchanger 67″ through a line L12″. It is understood that the heat exchanger 67″ can be in direct fluid communication with the tank 60″, shown in FIG. 3, through the line L11″ if desired. In the embodiment shown, the heat exchanger 67″ is an economizer adapted to use a hot feed to heat the fatty acid alkyl ester stream, although it is understood that the heat exchanger 67″ can be any conventional heat exchanger such as a shell and tube heat exchanger, a plate and frame heat exchanger, and a spiral heat exchanger, for example.

The heat exchanger 67″ is in fluid communication with another heat exchanger 68″ through a line L13″. It is understood that the heat exchanger 68 can be any conventional heat exchanger such as a shell and tube heat exchanger, a plate and frame heat exchanger, and a spiral heat exchanger, for example. The heat exchanger 68″ is adapted to further heat the fatty acid alky ester stream to a desired temperature using a heated fluid 69″ such as steam, hot water, and heated heat transfer fluid, for example. Although the desired temperature of the fatty acid alkyl ester stream in the embodiment shown is in a range of 150 degrees Fahrenheit to 350 degrees Fahrenheit, it is understood that the temperature can vary as desired.

The heat exchanger 68″ is in fluid communication with an evaporator 71″ through a line L14″, wherein the evaporator 71″ is under a vacuum provided by a vacuum pump (not shown). In the embodiment shown, the vacuum is in a range of 2 inches mercury to 26 inches mercury, although it is understood that the vacuum can vary as desired. It is also understood that the evaporator 71″ can be any conventional evaporator such as a flash tank, a rising film evaporator, a falling film evaporator, and a packed stripping column, for example. The evaporator 71″ is adapted to distill the fatty acid alkyl esters, separating the alcohol and the water vapor from an alkyl ester stream, wherein the alkyl ester stream includes alkyl esters and the soaps.

The evaporator 71″ is in fluid communication a condenser 74″ through a line L16′. The condenser 74′ is in fluid communication with another condenser 76′ through a line L17″. It is understood that the condensers 74″, 76″ can be any conventional condensers as desired. The condenser 74″ is adapted to use a cooled fluid 75″ such as water, for example, at a desired temperature to condense the alcohol and the water vapor flashed off by the evaporator 71″. In the embodiment shown, the desired temperature of the cooled fluid 75″ is in a range of 40 degrees Fahrenheit to 95 degrees Fahrenheit, although it is understood that the temperature can vary as desired. The condenser 76″ is adapted to use a chilled fluid 77″ such as water, a glycol solution, and the like, for example, at a desired temperature to condense the alcohol and the water vapor not condensed by the condenser 74′″. In the embodiment shown, the desired temperature of the chilled fluid 77′″ is in a range of 0 degrees Fahrenheit to 40 degrees Fahrenheit, although it is understood that the temperature can vary as desired.

The condenser 76″ is in fluid communication with a vacuum pump 78″ through a line L18″. The vacuum pump 78″ is adapted to permit any remaining alcohol and water vapor not condensed by the condensers 74″, 76″ to flow therethrough. The vacuum pump 78″ is in fluid communication with a pollution control device through a line L19″. In the embodiment shown, the pollution control device is the thermal oxidizer 50″, although it is understood that the pollution control device can be any control device such as a carbon adsorption system and a scrubber, for example. The pollution control device is adapted to receive any remaining alcohol and water vapor.

The condensers 74″, 76″ are also in fluid communication with a collection tank 79″ through a line L20″. It is understood that the tank 79″ can be any conventional tank as desired. The tank 79″ is adapted to receive a recovered alcohol fluid from the condensers 74″, 76″, wherein the recovered alcohol fluid includes alcohol and water.

In the embodiment shown, a tank 84″ is in fluid communication with a collection tank 58, shown in FIG. 3, through the line L25″. The tank 84″ can be any conventional tank as desired. The tank 84″ is also in fluid communication with the tank 79″ through a line L48 and a heat exchanger 85″ through a line L26″. It is understood that the heat exchanger 85″ can be in direct fluid communication with the tank 58, shown in FIG. 3, through the line L25″ if desired. In the embodiment shown, the heat exchanger 85″ is an economizer adapted to use a hot feed to heat the glycerol stream, although it is understood that the heat exchanger 85″ can be any conventional heat exchanger such as a shell and tube heat exchanger, a plate and frame heat exchanger, and a spiral heat exchanger, for example.

The heat exchanger 85″ is in fluid communication with another heat exchanger 86″ through a line L27″. The heat exchanger 86″ can be any conventional heat exchanger such as a shell and tube heat exchanger, a plate and frame heat exchanger, and a spiral heat exchanger, for example. The heat exchanger 86″ is adapted to further heat the glycerol stream to a desired temperature using a heated fluid 87″ such as steam, hot water, and heated heat transfer fluid, for example. Although the desired temperature of the glycerol stream in the embodiment shown is in a range of 140 degrees Fahrenheit to 220 degrees Fahrenheit, it is understood that the temperature can vary as desired.

The heat exchanger 86″ is in fluid communication with an evaporator 89″ through a line L28″, wherein the evaporator 89″ is under a vacuum provided by a vacuum pump (not shown). In the embodiment shown, the vacuum is in a range of 2 inches mercury to 26 inches mercury, although it is understood that the vacuum can vary as desired. It is also understood that the evaporator 89″ can be any conventional evaporator such as a flash tank, a rising film evaporator, a falling film evaporator, and a packed stripping column, for example. The evaporator 89″ is adapted to distill the glycerol stream, separating the alcohol vapor from a glycerin stream, wherein the glycerin stream includes glycerin, water, and soaps. Although an amount of glycerin is in a range of 100 pounds to 130 pounds, an amount of water is in a range of 0 pounds to 9 pounds, and an amount of soaps is in a range of 1 pound to 4 pounds, it is understood the amounts of the glycerin, the water, and the soaps can vary as desired. In the embodiment shown, the evaporator 89″ is in fluid communication with a reboiler 90″ through a circulation line L29″. The reboiler 90″ is adapted to further heat the glycerin stream using a heated fluid 91″ such as steam, for example.

The evaporator 89″ is also in fluid communication with a condenser 130 through a line L49. It is understood that the condenser 130 can be any conventional condenser such as a shell and tube condenser and a plate and frame condenser, for example. The condenser 130 is adapted to use a cooled fluid 132 such as water, for example, at a desired temperature to condense the alcohol vapor flashed off by the evaporator 89″. In the embodiment shown, the desired temperature of the cooled fluid 132 is in a range of 40 degrees Fahrenheit to 95 degrees Fahrenheit, although it is understood that the temperature can vary as desired.

The condenser 130 is in fluid communication with another condenser 134 through a line L50. It is understood that the condenser 134 can be any conventional condenser as desired. The condenser 134 is adapted to use a chilled fluid 136 such as water, a glycol solution, and the like, for example, at a desired temperature to condense the alcohol vapor not condensed by the condenser 130. In the embodiment shown, the desired temperature of the chilled fluid 136 is in a range of 0 degrees Fahrenheit to 40 degrees Fahrenheit, although it is understood that the temperature can vary as desired.

The condenser 134 is in fluid communication with a vacuum pump 138 through a line L52. The vacuum pump 138 is adapted to permit any remaining alcohol vapor not condensed by the condensers 130, 134 to flow therethrough. The vacuum pump 138 is in fluid communication with a pollution control device through a line L53. In the embodiment shown, the pollution control device is the thermal oxidizer 50″, although it is understood that the pollution control device can be any pollution control device such as a carbon adsorption system and a scrubber, for example. The pollution control device is adapted to receive any remaining alcohol vapor.

The condensers 130, 134 are also in fluid communication with a collection tank 140 through a line L55. The tank 140 is adapted to receive a recovered alcohol fluid from the condensers 130, 134, wherein the recovered alcohol fluid includes alcohol and water.

The tank 140 is in fluid communication with a tank 92″ through a line L57a. The tank 92″ can be any conventional tank as desired. The tank 92″ is adapted to store at least a fraction of the recovered alcohol fluid. The tank 140 is also in fluid communication with a tank 98″ through a line L57b. The tank 98″ can be any conventional tank as desired. The tank 98″ is adapted to store a predetermined amount of the recovered alcohol fluid for reuse in the reaction process 12. The tank 98″ is in fluid communication with the subsystem 20 through a line L32″.

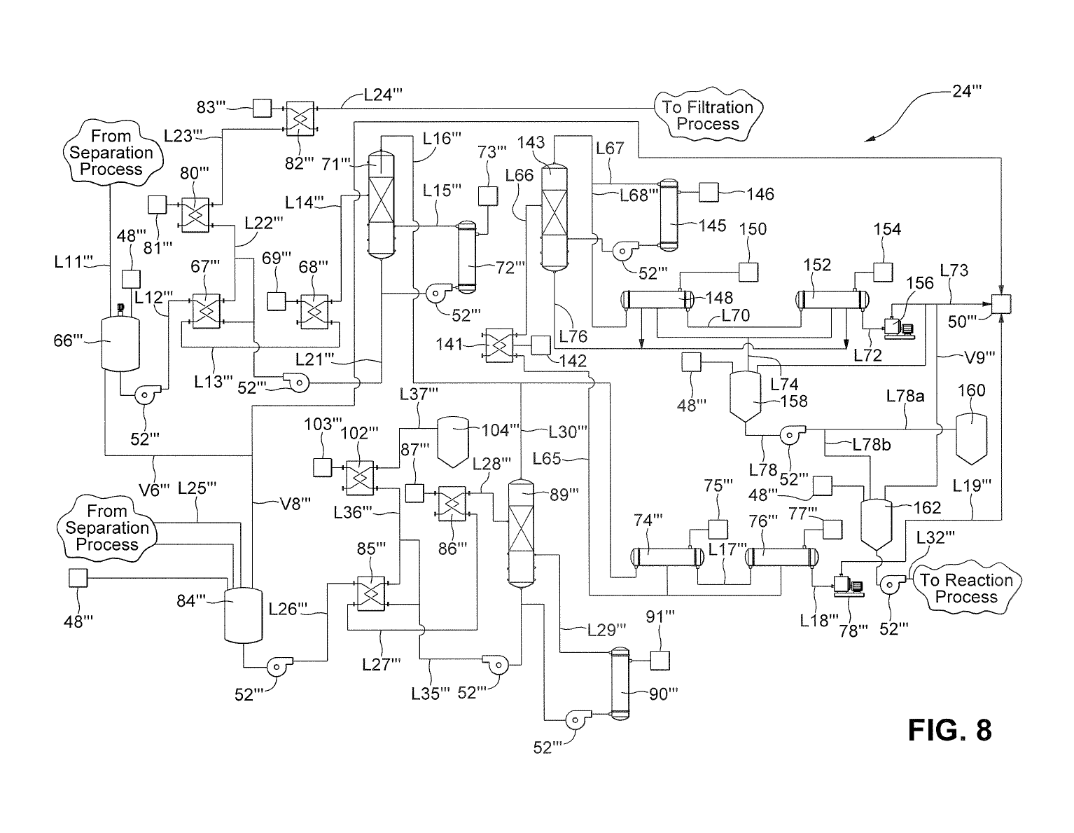

FIG. 8 illustrates another embodiment of the subsystem 24. Reference numerals for similar structure in respect of the description of FIGS. 4 and 7 are repeated in FIG. 8 with a prime (′″) symbol.

In the embodiment shown, a tank 66′″ is in fluid communication with the collection tank 60, shown in FIG. 3, through a line L11′″. The tank 66′″ can be any conventional tank as desired. The tank 66′″ is also in fluid communication with a heat exchanger 67′″ through a line L12′″. It is understood that the heat exchanger 67′″ can be in direct fluid communication with the tank 60, shown in FIG. 3, through the line L11′″ if desired. In the embodiment shown, the heat exchanger 67′″ is an economizer adapted to use a hot feed to heat the fatty acid alkyl ester stream, although it is understood that the heat exchanger 67′″ can be any conventional heat exchanger such as a shell and tube heat exchanger, a plate and frame heat exchanger, and a spiral heat exchanger, for example.

The heat exchanger 67′″ is in fluid communication with another heat exchanger 68′″ through a line L13′″. It is understood that the heat exchanger 68′″ can be any conventional heat exchanger such as a shell and tube heat exchanger, a plate and frame heat exchanger, and a spiral heat exchanger, for example. The heat exchanger 68′″ is adapted to further heat the fatty acid alky ester stream to a desired temperature using a heated fluid 69′″ such as steam, hot water, and heated heat transfer fluid, for example. Although the desired temperature of the fatty acid alkyl ester stream in the embodiment shown is in a range of 150 degrees Fahrenheit to 350 degrees Fahrenheit, it is understood that the temperature can vary as desired.

The heat exchanger 68′″ is in fluid communication with an evaporator 71′″ through a line L14′″, wherein the evaporator 71′″ is under a vacuum provided by a vacuum pump (not shown). In the embodiment shown, the vacuum is in a range of 2 inches mercury to 26 inches mercury, although it is understood that the vacuum can vary as desired. It is also understood that the evaporator 71′″ can be any conventional evaporator such as a flash tank, a rising film evaporator, a falling film evaporator, and a packed stripping column, for example. The evaporator 71′″ is adapted to distill the fatty acid alkyl esters, separating the alcohol and the water vapor from an alkyl ester stream, wherein the alkyl ester stream includes alkyl esters and the soaps.

In the embodiment shown, the evaporator 71′″ is in fluid communication with a reboiler 72′″ through a circulation line L15′″. The reboiler 72′″ is adapted to further heat the alkyl esters using a heated fluid 73′″ such as steam, for example.

In the embodiment shown, a tank 84′″ is in fluid communication with the collection tank 58, shown in FIG. 3, through the line L259′″. The tank 84′″ can be any conventional tank as desired. The tank 84′″ is also in fluid communication with a heat exchanger 85′″ through a line L26′″. It is understood that the heat exchanger 85′″ can be in direct fluid communication with the tank 58, shown in FIG. 3, through the line L25′″ if desired. In the embodiment shown, the heat exchanger 85′″ is an economizer adapted to use a hot feed to heat the glycerol stream, although it is understood that the heat exchanger 85′″ can be any conventional heat exchanger such as a shell and tube heat exchanger, a plate and frame heat exchanger, and a spiral heat exchanger, for example.

The heat exchanger 85′″ is in fluid communication with another heat exchanger 86′″ through a line L27′″. The heat exchanger 86′″ can be any conventional heat exchanger such as a shell and tube heat exchanger, a plate and frame heat exchanger, and a spiral heat exchanger, for example. The heat exchanger 86′″ is adapted to further heat the glycerol stream to a desired temperature using a heated fluid 87′″ such as steam, hot water, and heated heat transfer fluid, for example. Although the desired temperature of the glycerol stream in the embodiment shown is in a range of 140 degrees Fahrenheit to 220 degrees Fahrenheit, it is understood that the temperature can vary as desired.

The heat exchanger 86′″ is in fluid communication with an evaporator 89′″ through a line L28′″, wherein the evaporator 89′″ is under a vacuum provided by a vacuum pump (not shown). In the embodiment shown, the vacuum is in a range of 2 inches mercury to 26 inches mercury, although it is understood that the vacuum can vary as desired. It is also understood that the evaporator 89 can be any conventional evaporator such as a flash tank, a rising film evaporator, a falling film evaporator, and a packed stripping column, for example. The evaporator 89′″ is adapted to distill the glycerol stream, separating the alcohol vapor from a glycerin stream, wherein the glycerin stream includes glycerin, water, and soaps. In the embodiment shown, the evaporator 89 is in fluid communication with a reboiler 90′″ through a circulation line L29. The reboiler 90′″ is adapted to further heat the glycerin stream using a heated fluid 91′″, such as steam, for example.

Each of the evaporators 71′″, 89′″ is also in fluid communication with a condenser 74′″ through respective lines L16′″, L30′″. It is understood that the condenser 74′″ can be any conventional condenser such as a shell and tube condenser and a plate and frame condenser, for example. The condenser 74′″ is adapted to use a cooled fluid 75′″ such as water, for example, at a desired temperature to condense the alcohol and the water vapor flashed off by the evaporator 71′″ into a recovered alcohol fluid, wherein the recovered alcohol fluid includes alcohol and water. In the embodiment shown, the desired temperature the cooled fluid 75′″ is in a range of 40 degrees Fahrenheit to 95 degrees Fahrenheit, although it is understood that the temperature can vary as desired.

The condenser 74′″ is in fluid communication with another condenser 76′″ through a line L17′″. It is understood that the condenser 76′″ can be any conventional condenser as desired. The condenser 76′″ is adapted to use a chilled fluid 77′″ such as water, a glycol solution, and the like, for example, at a desired temperature to condense the alcohol and the water vapor not condensed by the condenser 74′″ into the recovered alcohol fluid. In the embodiment shown, the desired temperature of the chilled fluid 77′″ is in a range of 0 degrees Fahrenheit to 40 degrees Fahrenheit, although it is understood that the temperature can vary as desired.

The condenser 76′″ is in fluid communication with a vacuum pump 78′″ through a line L18′″. The vacuum pump 78′″ is adapted to permit any remaining alcohol and water vapor not condensed by the condensers 74′″, 76′″ to flow therethrough. The vacuum pump 78′″ is in fluid communication with a pollution control device through a line L19′″. In the embodiment shown, the pollution control device is the thermal oxidizer 50′″, although it is understood that the pollution control device can be any control device such as a carbon adsorption system and a scrubber, for example. The pollution control device is adapted to receive any remaining alcohol and water vapor.

The condensers 74′″, 76′″ are in fluid communication with a heat exchanger 141 through a line L65. The heat exchanger 141 is adapted to receive the recovered alcohol fluid from the condensers 74′″, 76′″. In the embodiment shown, the heat exchanger 141 is an economizer adapted to heat the recovered alcohol fluid to a desired temperature using a heated fluid 142 such as steam, for example. Although the desired temperature is in a range of 150 degrees Fahrenheit to 180 degrees Fahrenheit, it is understood that the temperature can vary as desired. It is also understood that the heat exchanger can be any conventional heat exchanger such as a shell and tube heat exchanger, a plate and frame heat exchanger, and a spiral heat exchanger, for example.

The heat exchanger 141 is in fluid communication with an evaporator 143 through a line L66, wherein the evaporator 143 is under a vacuum provided by a vacuum pump (not shown). In the embodiment shown, the vacuum is in a range of 2 inches mercury to 26 inches mercury, although it is understood that the vacuum can vary as desired. It is also understood that the evaporator 143 can be any conventional evaporator such as a flash tank, a rising film evaporator, a falling film evaporator, and a packed stripping column, for example. In the embodiment shown, the evaporator 143 is in fluid communication with a reboiler 145 through a circulation line L67. The reboiler 145 is adapted to further heat the alkyl esters using a heated fluid 146 such as steam, for example. The evaporator 143 is adapted to remove any remaining water and purify the recovered alcohol fluid collected from the evaporators 71′″, 89′″. In the embodiment shown, the evaporator 143 is adapted to purify the recovered alcohol fluid to a 99% purity level for reuse in the reaction process 12.

The evaporator 143 is also in fluid communication with a condenser 148 through a line L68. It is understood that the condenser 148 can be any conventional condenser such as a shell and tube condenser and a plate and frame condenser, for example. The condenser 148 is adapted to use a cooled fluid 150 such as water, for example, at a desired temperature to condense the alcohol and the water vapor flashed off by the evaporator 143 into a purified alcohol fluid, wherein the purified alcohol fluid includes alcohol and water. In the embodiment shown, the desired temperature of the cooled fluid 150 is in a range of 40 degrees Fahrenheit to 95 degrees Fahrenheit, although it is understood that the temperature can vary as desired.

The condenser 148 is in fluid communication with another condenser 152 through a line L70. It is understood that the condenser 152 can be any conventional condenser as desired. The condenser 152 is adapted to use a chilled fluid 154 such as water, a glycol solution, and the like, for example, at a desired temperature to condense the alcohol and the water vapor not condensed by the condenser 148 into the purified alcohol fluid. In the embodiment shown, the desired temperature of the chilled fluid 154 is in a range of 0 degrees Fahrenheit to 40 degrees Fahrenheit, although it is understood that the temperature can vary as desired.

The condenser 152 is in fluid communication with a vacuum pump 156 through a line L72. The vacuum pump 156 is adapted to permit any remaining alcohol and water vapor not condensed by the condensers 148, 152 to flow therethrough. The vacuum pump 156 is in fluid communication with a pollution control device through a line L73. In the embodiment shown, the pollution control device is the thermal oxidizer 50′″, although it is understood that the pollution control device can be any control device such as a carbon adsorption system and a scrubber, for example. The pollution control device is adapted to receive any remaining alcohol and water vapor.

The condensers 148, 152 are also in fluid communication with a collection tank 158 through a line L74. It is understood that the tank 158 can be any conventional tank as desired. The tank 158 is adapted to receive the purified alcohol fluid from the condensers 148, 152.

The condensers 148, 152 are also in fluid communication with the evaporator 143 through a line L76 to circulate a predetermined amount of the purified alcohol fluid back to the evaporator 143 to control the purity of the purified alcohol fluid. In the embodiment shown, the predetermined amount of the purified alcohol fluid is in a range of 20% to 70% of the total amount of the purified alcohol fluid. It is understood that the amount of the purified alcohol fluid circulated back to the evaporator 143 can vary as desired.

The tank 158 is in fluid communication with a tank 160 through a line L78a. The tank 160 can be any conventional tank as desired. The tank 160 is adapted to store at least a fraction of the purified alcohol fluid. The tank 158 is also in fluid communication with a tank 162 through a line L78b. The tank 162 can be any conventional tank as desired. The tank 162 is adapted to store a predetermined amount of the purified alcohol fluid for reuse in the reaction process 12. The tank 162 is in fluid communication with the subsystem 20 through a line L32′″.

In operation, the predetermined amount of the organic fluid is fed into one of the tank 32 and the static mixer. In the embodiment shown, the organic fluid is caused by one of the pumps 52 to flow from the tank 30 through the line L1 to one of the tank 32 and the static mixer. The preheater 33 preheats the organic fluid to the desired temperature. The predetermined amount of the catalyst and the predetermined amount of the alcohol are also fed into one of the tank 32 and the static mixer to produce the pre-reaction mixture. The catalyst and the alcohol are also caused by the pumps 52 to flow from respective tanks 40, 42 through lines L2, L3. It is understood that the recovered alcohol may be circulated from the distillation process 16 and fed into the line L3 through the line L32. The predetermined amount of water may be fed into one of the tank 32 and the static mixer.

The pre-reaction mixture is then caused by one of the pumps 52 to flow from one of the tank 32 and the static mixer through the line L4 to the reactor 34. The process liquid produced from the reactor 34 is then caused by one of the pumps 52 to flow through the line L5 to the tank 46. It is understood that the process liquid can be circulated through the L6 to one of the tank 32 and the static mixer, and the reactor 34 until the reaction is complete. In the embodiment shown, the tanks 46, 48 are blanketed with the nitrogen 48. The nitrogen 48 is then vented to the thermal oxidizer 50 through the vents V1, V2, respectively.

As shown in FIG. 3, the predetermined amount of the process liquid is caused by one of the pumps 52 to flow from the tank 46 through a line L7 to the tank 54. Thereafter, a continuous feed of the process liquid is caused by one of the pumps 52 to flow from the tank 54 through the at least one line L8 to the at least one separator 56. The at least one separator 56 separates the glycerol in the process fluid from the fatty acid alkyl esters, producing a glycerol stream and a fatty acid alkyl ester stream. Each of the streams is then caused to flow through respective lines L9, L10 to collection tanks 58, 60. Solids remaining in the at least one separator 56 such as the soaps and the salts, for example, are discharged onto the conveyor 62 for transport to the disposal container 64. In the embodiment shown, the tanks 54, 58, 60 and the at least one separator 56 are blanketed with the nitrogen 48. The nitrogen 48 is then vented to the thermal oxidizer 50 through the vents V3, V4, V5, respectively.

As illustrated in FIG. 4, the fatty acid alkyl ester stream is caused by one of the pumps 52 to flow from the tank 60 through the line L11 to the tank 66. Thereafter, a continuous feed of the alkyl ester stream is caused by one of the pumps 52 to flow through the line L12 to the heat exchanger 67. It is understood that the fatty acid alkyl ester stream may be caused by one of the pumps 52 to flow from the tank 60 through the line L11 directly to the heat exchanger 67. The heat exchanger 67 heats the fatty acid alkyl ester stream to a temperature below the desired temperature. The fatty acid alkyl ester stream is then caused to flow through the line L13 to the heat exchanger 68. The heat exchanger 68 heats the fatty acid alkyl ester stream to the desired temperature. From the heat exchanger 68, a continuous feed of the fatty acid alkyl ester stream flows through the line L14 to the evaporator 71. The evaporator 71 heats and distills the fatty acid alkyl ester stream to remove the alcohol and water from the alkyl esters and the soaps. The alcohol and water vapor produced from the evaporator 71 then flows through the line L16 to the condenser 74. The condenser 74 condenses the alcohol and water vapor into a recovered alcohol fluid. The recovered alcohol fluid flows from the condenser 74 through the line L20 to the collection tank 79. Thereafter, the alcohol and water vapor flows from the condenser 74 through the L17 to the condenser 76. The condenser 76 condenses the alcohol and water vapor into the recovered alcohol fluid. The recovered alcohol fluid flows from the condenser 76 through the line L20 to the collection tank 79. Any remaining alcohol and water vapor flows from the condenser 76 through the line L18 to the vacuum pump 78 and through line L19 to the thermal oxidizer 50.

The alkyl ester stream is caused by one of the pumps 52 to flow from the evaporator 71 through the line L21 to the heat exchanger 67. The heat exchanger 67 cools the alkyl ester stream to a temperature above the desired temperature. The alkyl ester stream is then caused to flow through the line L22 to the heat exchanger 80. The heat exchanger 80 cools the alkyl ester stream to a temperature above the desired temperature. From the heat exchanger 80, the cooled alkyl ester stream flows through the line L23 to the heat exchanger 82. The heat exchanger 82 cools the alkyl ester stream to the desired temperature.

Simultaneously, the glycerol stream is caused by one of the pumps 52 to flow from the tank 58 through the line L25 to the tank 84. Thereafter, a continuous feed of the glycerol stream is caused by one of the pumps 52 to flow through the line L26 to the heat exchanger 85. It is understood that the glycerol stream may be caused by one of the pumps 52 to flow from the tank 58 through the L25 directly to the heat exchanger 85 if desired. The heat exchanger 85 heats the glycerol stream to a temperature below the desired temperature. The glycerol stream is then caused to flow through the line L27 to the heat exchanger 86. The heat exchanger 86 heats the glycerol stream to the desired temperature. From the heat exchanger 86, a continuous feed of the glycerol stream flows through the line L28 to the evaporator 89. The evaporator 89 heats and distills the glycerol stream to remove the alcohol from the glycerin, the water, and the soaps. The alcohol vapor produced from the evaporator 89 then flows through the line L30 to the condenser 74. The condenser 74 condenses the alcohol vapor into a recovered alcohol fluid. The recovered alcohol fluid flows from the condenser 74 through the line L20 to the collection tank 79. Thereafter, the alcohol vapor flows from the condenser 74 through the line L17 to the condenser 76. The condenser 76 condenses the alcohol vapor into the recovered alcohol fluid. The recovered alcohol fluid flows from the condenser 76 through the line L20 to the collection tank 79. Any remaining alcohol vapor flows from the condenser 76 through the line L18 to the vacuum pump 78 and through line L19 to the thermal oxidizer 50.

The glycerin stream is caused by one of the pumps 52 to flow from the evaporator 89 through the line L35 to the heat exchanger 85. The heat exchanger 85 cools the glycerin stream to a temperature above the desired temperature. From the heat exchanger 85, the cooled glycerin stream flows through the line L36 to the heat exchanger 102. The heat exchanger 102 cools the glycerin stream to the desired temperature. Thereafter, the cooled glycerin stream flows from the heat exchanger 102 through the line L37 to the tank 104.

The recovered alcohol fluid collected in the tank 79 is caused by one of the pumps 52 to flow from the tank 79 through the line L31 to one of the tank 92 and the tank 98. Thereafter, the recovered alcohol fluid is caused by one of the pumps 52 to flow from the tank 98 through the line L32 to the subsystem 20 for reuse in the reaction process 12. The densitometer 99 determines the quantity of water in the recovered alcohol fluid flowing through the line L31. If the quantity of water is above the desired amount, the recovered alcohol fluid is diverted through the line L33 into the tank 100. Thereafter, the tank 100 regulates the flow of the recovered alcohol fluid through the line L34 to the tank 98 to meet the water requirement of the subsystem 20. It is understood that the predetermined amount of water which may be fed into one of the tank 32 and the static mixer from the fourth tank is one of increased and decreased depending on the quantity of water in the recovered alcohol fluid.

As illustrated in FIG. 5, the cooled alkyl ester stream flows from the heat exchanger 82, shown in FIG. 4, through the line L24 to the tank 106. The predetermined amount of filter aid is caused by the feeder 110 to be fed from the tank 108 through the line L38 into the tank 106. One of the blowers 120 causes the filter aid to be fed from one of the unloaders 118 into the tank 108.

The predetermined amount of precoat material is caused by the feeder 116 to be fed from the tank 114 through the line L39 into the tank 112. Another one of the blowers 120 causes the precoat material to be fed from another one of the unloaders 118 into the tank 114. The precoat material is mixed with the methyl to produce the precoat slurry. The precoat slurry is then caused by one of the pumps 52 to flow from the tank 112 through the line L42 to the filter 122, depositing a layer of the slurry on at least one of the plurality of screens 123 and the fabric.

Once the filter 122 is precoated with the precoat slurry, the alkyl ester stream mixed with the filter aid is caused by one of the pumps 52 to flow from the tank 106 through the line L42 to the filter 122. Thereafter, the alkyl ester stream flows through the filter 122, thereby removing the filter aid and other impurities. The filtered alkyl ester stream is then caused by one of the pumps 52 to flow from the filter 122 through the line L46 and through the cloth filters 124 to produce the final alkyl ester product. Thereafter, the final alkyl ester product flows from the cloth filters 124 through the line L47 to the tank 126 for storage.

The filter aid and other impurities removed by the filter 122 are transported to the disposal container 130 by at least one conveyor 128. It is understood that the filter aid and other impurities could be further processed to extract any remaining alkyl esters.

In the embodiment shown in FIG. 6, the stream of organic fluid is continuously fed into the at least one reactor 34′. The organic fluid is caused by one of the pumps 52′ to flow from the tank 301 through the line L1′ to the at least one reactor 34′. The heat exchanger 32′ preheats the organic fluid to the desired temperature. The stream of catalyst and the stream of alcohol are also continuously fed into the at least one reactor 34′. The stream of catalyst and the stream of alcohol caused by the pumps 52′ to flow from respective storage tanks 30′, 40′ through respective lines L2′, L3′ to the at least one reactor 34′. It is understood that the recovered alcohol may be circulated from the distillation process 16 and fed into the line L3′ through the line L31′. The stream of water may be continuously fed from the tank through the line into the at least one reactor 34′.

The process liquid produced from the at least one reactor 34′ is then caused by one of the pumps 52′ to flow through a line L6′ to the tank 46′. It is understood that the process liquid can be circulated from the tank 46′ through the at least one reactor 34′ until the reaction is complete. In the embodiment shown, the tank 46′ is blanketed with the nitrogen 48′. The nitrogen 48′ is then vented to the thermal oxidizer 50′ though the vent V2′.

In the embodiment shown in FIG. 7, the fatty acid alkyl ester stream is caused by one of the pumps 52″ to flow from the tank 60 through the line L1″ to the tank 66″. Thereafter, a continuous feed of the alkyl ester stream is caused by one of the pumps 52″ to flow through the line L12″ to the heat exchanger 67″. It is understood that the fatty acid alkyl ester stream may be caused by one of the pumps 52″ to flow from the tank 60 through the L11″ directly to the heat exchanger 67″. The heat exchanger 67″ heats the fatty acid alkyl ester stream to a temperature below the desired temperature. The fatty acid alkyl ester stream is then caused to flow through the line L13″ to the heat exchanger 68″. The heat exchanger 68″ heats the fatty acid alkyl ester stream to the desired temperature. From the heat exchanger 68″, a continuous feed of the fatty acid alkyl ester stream flows through the line L14″ to the evaporator 71″. The evaporator 71″ heats and distills the fatty acid alkyl ester stream to remove the alcohol and water from the alkyl esters and the soaps. The alcohol and water vapor produced from the evaporator 71″ then flows through the line L16″ to the condenser 74″.

The condenser 74″ condenses the alcohol and water vapor into the recovered alcohol fluid. The recovered alcohol fluid flows from the condenser 74′″ through the line L20″ to the collection tank 79′. Thereafter, the alcohol and water vapor flows from the condenser 74″ through the L17″ to the condenser 76″. The condenser 76″ condenses the alcohol and water vapor into the recovered alcohol fluid. The recovered alcohol fluid flows from the condenser 76″ through the line L20″ to the collection tank 79″. Any remaining alcohol and water vapor flows from the condenser 76″ through the line L18″ to the vacuum pump 78″ and through line L19″ to the thermal oxidizer 50″.

The recovered alcohol fluid is then caused by one of the pumps 52″ to flow from the tank 79″ through the line L48 to the tank 84″. Once in the tank 84″ the recovered alcohol fluid is mixed with the glycerol stream. The glycerol stream is then caused by one of the pumps 52″ to flow through the line L26″ to the heat exchanger 85″. The heat exchanger 85″ heats the glycerol stream to a temperature below the desired temperature. The glycerol stream is then caused to flow through the line L27″ to the heat exchanger 86″. The heat exchanger 86″ heats the glycerol stream to the desired temperature. From the heat exchanger 86″, a continuous feed of the glycerol stream flows through the line L28″ to the evaporator 89″. The evaporator 89″ heats and distills the glycerol stream to remove the alcohol from the glycerin, the water, and the soaps.

The alcohol vapor produced from the evaporator 89″ then flows through the line L49 to the condenser 130. The condenser 130 condenses the alcohol vapor into the recovered alcohol fluid. The recovered alcohol fluid flows from the condenser 130 through the line L55 to the collection tank 140. Thereafter, the alcohol vapor flows from the condenser 130 through the line L50 to the condenser 134. The condenser 134 condenses the alcohol vapor into the recovered alcohol fluid. The recovered alcohol fluid flows from the condenser 134 through the line L55 to the collection tank 140. Any remaining alcohol vapor flows from the condenser 134 through the line L52 to the vacuum pump 138 and through line L53 to the thermal oxidizer 50″.

The recovered alcohol fluid collected in the tank 140 is caused by one of the pumps 52″ to flow from the tank 140 through one of the line L57a to the tank 92″ for storage and the line L57b to the tank 98″. Thereafter, the recovered alcohol fluid is caused by one of the pumps 52″ to flow from the tank 98″ through the line L32″ to the subsystem 20 for reuse in the reaction process 12.

In the embodiment shown in FIG. 8, the fatty acid alkyl ester stream is caused by one of the pumps 52′″ to flow from the tank 60 through the line L1.′″ to the tank 66′″. Thereafter, a continuous feed of the alkyl ester stream is caused by one of the pumps 52′″ to flow through the line L12′″ to the heat exchanger 67′″. It is understood that the fatty acid alkyl ester stream may be caused by one of the pumps 52′″ to flow from the tank 60 through the L11′″ directly to the heat exchanger 67′″. The heat exchanger 67′″ heats the fatty acid alkyl ester stream to a temperature below the desired temperature. The fatty acid alkyl ester stream is then caused to flow through the line L13′″ to the heat exchanger 68′″. The heat exchanger 68′″ heats the fatty acid alkyl ester stream to the desired temperature. From the heat exchanger 68′″, a continuous feed of the fatty acid alkyl ester stream flows through the line L14′″ to the evaporator 71′″. The evaporator 71′″ heats and distills the fatty acid alkyl ester stream to remove the alcohol and water from the alkyl esters and the soaps. The alcohol and water vapor produced from the evaporator 71′″ then flows through the line L16′″ to the condenser 74′″. The condenser 74′″ condenses the alcohol and water vapor into the recovered alcohol fluid. The recovered alcohol fluid flows from the condenser 74′″ through the line L65 to the heat exchanger 141. Thereafter, the alcohol and water vapor flows from the condenser 74′″ through the L17′″ to the condenser 76′″. The condenser 76′″ condenses the alcohol and water vapor into the recovered alcohol fluid. The recovered alcohol fluid flows from the condenser 76′″ through the line L65 to the heat exchanger 141. Any remaining alcohol and water vapor flows from the condenser 76′″ through the line L18.″ to the vacuum pump 78′″ and through line L19′″ to the thermal oxidizer 50′″.

The glycerol stream is caused by one of the pumps 52′″ to flow from the tank 58 through the line L25′″ to the tank 84′″. Thereafter, a continuous feed of the glycerol stream is caused by one of the pumps 52′″ to flow through the line L26′″ to the heat exchanger 85′″. It is understood that the glycerol stream may be caused by one of the pumps 52′″ to flow from the tank 58 through the L25′″ directly to the heat exchanger 85′″. The heat exchanger 85′″ heats the glycerol stream to a temperature below the desired temperature. The glycerol stream is then caused to flow through the line L27′″ to the heat exchanger 86′″. The heat exchanger 86′″ heats the glycerol stream to the desired temperature. From the heat exchanger 86′″, a continuous feed of the glycerol stream flows through the line L28′″ to the evaporator 89′″. The evaporator 89′″ heats and distills the glycerol stream to remove the alcohol from the glycerin, the water, and the soaps. The alcohol vapor produced from the evaporator 89′″ then flows through the line L30′″ to the condenser 74′″. The condenser 74′″ condenses the alcohol vapor into the recovered alcohol fluid. The recovered alcohol fluid flows from the condenser 74′″ through the line L65 to the heat exchanger 141. Thereafter, the alcohol vapor flows from the condenser 74′″ through the line L17′″ to the condenser 76′″. The condenser 76′″ condenses the alcohol vapor into the recovered alcohol fluid. The recovered alcohol fluid flows from the condenser 76′″ through the line L65 to the heat exchanger 141. Any remaining alcohol vapor flows from the condenser 76′″ through the line L18′″ to the vacuum pump 78′″ and through line L19′″ to the thermal oxidizer 50′″.

The heat exchanger 141 heats the recovered alcohol fluid from the condensers 74′″, 76′″ to the desired temperature. Thereafter, the recovered alcohol fluid is fed from the heat exchanger 141 through the line L66 into the evaporator 143 operating under the vacuum. The alcohol is then flashed off and flows from the evaporator 143 through the line L68 to the condenser 148.

The condenser 148 condenses the alcohol vapor into the purified alcohol fluid. The purified alcohol fluid flows from the condenser 148 through the line L74 to the collection tank 158. Thereafter, the alcohol vapor flows from the condenser 148 through the line L70 to the condenser 152. The condenser 152 further condenses the alcohol vapor into the purified alcohol fluid. The purified alcohol fluid flows from the condenser 152 through the line L74 to the collection tank 158. Any remaining alcohol vapor flows from the condenser 152 through the line L72 to the vacuum pump 156 and through line L73 to the thermal oxidizer 50′″. In the embodiment shown, a fraction of the purified alcohol fluid is circulated from the condensers 148, 152 through the line L76 to the evaporator 143 to control the purity of the purified alcohol fluid.

The purified alcohol fluid collected in the tank 158 is caused by one of the pumps 52′″ to flow from the tank 158 through one of the line L78a to the tank 160 and the line L78b to the tank 162. Thereafter, the purified alcohol fluid is caused by one of the pumps 52′″ to flow from the tank 162 through the line L32′″ to the subsystem 20 for reuse in the reaction process 12.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A system for producing biodiesel, the system comprising:
a plurality of storage tanks, each of the storage tanks adapted to contain one of an organic liquid, an alcohol, a recovered alcohol fluid, a purified alcohol fluid, a catalyst, a glycerin, and a final alkyl ester product;
at least one reactor in fluid communication with at least one of the storage tanks, the at least one reactor adapted to produce a process liquid from the organic liquid, the catalyst, and at least one of the alcohol, the recovered alcohol fluid, and the purified alcohol fluid;
at least one separator in fluid communication with the at least one reactor, the at least one separator adapted to separate the process liquid into a glycerol stream and a fatty acid alkyl ester stream;
a plurality of evaporators in fluid communication with the at least one separator, wherein one of the evaporators adapted to remove the alcohol and the water from the fatty acid alkyl ester stream to produce an alkyl ester stream, and another of the evaporators adapted to remove the alcohol from the glycerol stream to produce a glycerin stream;
a plurality of condensers in fluid communication with the evaporators, wherein each of the condensers is adapted to condense the alcohol and the water removed by the evaporators to produce the recovered alcohol fluid;
a plurality of heat exchangers in fluid communication with the evaporators and at least one of the storage tanks, wherein one of the heat exchangers is adapted to heat one of the fatty acid alkyl ester stream and the glycerol stream, and another of the heat exchangers is adapted to cool one of the alkyl ester stream and the glycerin stream;
a mixing tank in fluid communication with at least one of the heat exchangers, wherein the mixing tank is adapted to receive the alkyl ester stream and a filter aid adapted to adsorb impurities thereof; and
at least one filter in fluid communication with the mixing tank and one of the storage tanks, wherein the at least one filter is adapted to remove from the alkyl ester stream at least one of the filter aid and the impurities, to produce a final alkyl ester product.

2. The system according to claim 1, further comprising one of another mixing tank and a static mixer in fluid communication with at least one of the storage tanks and the at least one reactor, wherein the mixing tank and the static mixer are adapted to receive the organic liquid, the catalyst, and at least one of the alcohol, the recovered alcohol fluid, and the purified alcohol fluid, to produce a pre-reaction mixture.

3. The system according to claim 2, further comprising a preheater in fluid communication with one of the storage tanks and one of the at least one reactor, the mixing tank, and the static mixer, wherein one of the storage tanks is adapted to contain the organic fluid, and the preheater is adapted to heat the organic fluid to a desired temperature.

4. The system according to claim 1, further comprising a plurality of holding tanks, each of the holding tanks adapted to collect one of the process liquid, the fatty acid alkyl ester stream, the glycerol stream, the recovered alcohol fluid, and the purified alcohol fluid.

5. The system according to claim 4, further comprising at least one bypass tank in fluid communication with one of the holding tanks and one of the storage tanks, wherein the bypass tank is adapted to receive at least one of the recovered alcohol fluid and the purified alcohol fluid.

6. The system according to claim 5, further comprising a plurality of feed tanks, each of the feed tanks adapted to feed one of the process liquid into the at least one separator, the fatty acid alkyl ester stream into the at least one heat exchanger adapted to heat the fatty acid alkyl ester stream, the glycerol stream into the at least one heat exchanger adapted to heat the glycerol stream, and the filter aid into the mixing tank adapted to receive the alkyl ester stream and the filter aid.

7. The system according to claim 6, further comprising at least one heat exchanger in fluid communication with at least one evaporator, wherein the at least one heat exchanger is adapted to heat the recovered alcohol fluid, and the at least one evaporator is adapted to purify the recovered alcohol fluid.

8. The system according to claim 7, wherein the condensers are in fluid communication with one of the holding tanks adapted to collect at least one of the recovered alcohol fluid and the purified alcohol fluid and the at least one heat exchanger adapted to heat at least one of the recovered alcohol fluid, wherein the holding tanks are in fluid communication with at least one of the storage tanks adapted to contain at least one of the recovered alcohol fluid and the purified alcohol fluid, the at least one bypass tank, and the feeder tanks adapted to receive the glycerol stream.

9. The system according to claim 1, further comprising another mixing tank in fluid communication with the at least one filter, wherein the mixing tank is adapted to receive an alcohol and a precoat material to produce a precoat slurry.

10. The system according to claim 9, wherein the precoat material is diatomaceous earth.

11. The system according to claim 9, further comprising another feed tank, wherein the feed tank is adapted to feed the precoat material into the mixing tank adapted to receive the alcohol and the precoat material.

12. The system according to claim 1, further comprising a plurality of pumps.

13. The system according to claim 1, wherein the organic liquid is at least one of a triglyceride, a diglyceride, and a monoglyceride, the catalyst is at least one of a sodium methoxide, a potassium methoxide, and a lithium methoxide, the alcohol is at least one of a methanol and an ethanol, and the filter aid is at least one of a magnesium silicate and a bleaching clay.

14. A method of producing biodiesel comprising the steps of:
feeding an organic liquid, a catalyst, and at least one of an alcohol, a recovered alcohol fluid, and a purified alcohol fluid into at least one reactor to produce a process liquid;
feeding the process liquid into at least one separator, wherein the process liquid is separated into a fatty acid alkyl ester stream including an amount of fatty acid alkyl esters, alcohol, and water, and a glycerol stream including an amount of glycerin, alcohol, and water;
feeding the fatty acid alkyl ester stream into at least one evaporator for removal of the alcohol and water to produce an alkyl ester stream;
feeding the glycerol stream into at least one evaporator for removal of the alcohol to produce a glycerin stream;
feeding the alcohol and the water removed by the at least one evaporator into at least one condenser to produce the recovered alcohol fluid;
feeding the alkyl ester stream into a mixing tank, wherein the mixing tank is adapted to mix the alkyl ester stream with a filter aid; and
feeding the alkyl ester stream mixed with the filter aid through at least one filter to remove the filter aid and impurities to produce a final alkyl ester product.

15. The method according to claim 14, further comprising the step of feeding the recovered alcohol fluid into at least one evaporator to produce a purified alcohol fluid.

16. The method according to claim 14, further comprising the step of feeding the filtered alkyl ester stream through at least one cloth filter to produce the final alkyl ester product.

17. The method according to claim 14, further comprising precoating the at least one filter with a precoat slurry, wherein the precoat slurry includes an alcohol and a precoat material.

18. The method according to claim 14, wherein the organic liquid is at least one of a triglyceride, a diglyceride, and a monoglyceride, the catalyst is at least one of a sodium methoxide, a potassium methoxide, and a lithium methoxide, the alcohol is at least one of a methanol and an ethanol, and the filter aid is at least one of a magnesium silicate and a bleaching clay.

19. A method of producing biodiesel comprising the steps of:
feeding an organic liquid, a catalyst, and at least one of an alcohol, a recovered alcohol fluid, and a purified alcohol fluid into at least one reactor to produce a process liquid;
feeding the process liquid into at least one separator, wherein the process liquid is separated into a fatty acid alkyl ester stream including an amount of fatty acid alkyl esters, alcohol, and water, and a glycerol stream including an amount of glycerin, alcohol, and water;
feeding the fatty acid alkyl ester stream into at least one evaporator for removal of the alcohol and water to produce an alkyl ester stream;
feeding the glycerol stream into at least one evaporator for removal of the alcohol and water to produce a glycerin stream;
feeding the alcohol and the water removed by the at least one evaporator into at least one condenser to produce the recovered alcohol fluid;
feeding the recovered alcohol fluid into at least one evaporator to produce a purified alcohol fluid;
feeding the alkyl ester stream into a mixing tank, wherein the alkyl ester stream is mixed with a filter aid;
feeding the alkyl ester stream mixed with the filter aid through at least one filter to remove the filter aid and impurities to produce a filtered alkyl ester stream, wherein the at least one filter is precoated with a precoat slurry produced from an alcohol and a precoat material; and
feeding the filtered alkyl ester stream through at least one cloth filter to produce the final alkyl ester product.

20. The method according to claim 19, wherein the organic liquid is at least one of a triglyceride, a diglyceride, and a monoglyceride, the catalyst is at least one of a sodium methoxide, a potassium methoxide, and a lithium methoxide, the alcohol is at least one of a methanol and an ethanol, the filter aid is at least one of a magnesium silicate and a bleaching clay, and the precoat material is diatomaceous earth.
